(19) United States
(12) Patent Application Publication
(10) Pub. No.: US 2007/0011939 A1
(43) Pub. Date: Jan. 18, 2007

(54) Storage systems

(75) Inventor: Tatsuya Sakai, Irvine, CA (US)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: SHIMANO AMERICAN CORPORATION

(21) Appl. No.: 11/181,223

(22) Filed: Jul. 13, 2005

(51) Int. Cl. A01K 97/06

(52) U.S. Cl. 43/54.1

(57) ABSTRACT

A storage system for storing a plurality of hooked objects is provided. The storage system comprises at least one chamber having side walls and guide members disposed on the chamber side walls. The storage system further comprises partition members disposed in the chamber, the partition member comprising a body having apertures to support at least one hooked object. The partition members are supported in the chamber by at least one guide member in a substantially vertical position. A plurality of guide members may be disposed on the opposing side walls of the chamber, such that adjacent partition members may be positioned in the chamber at varying relative distances from one another to form compartments of varying sizes.

### FIELD OF THE INVENTION

The present invention relates generally to storage systems, and more particularly, to storage systems which may be adapted for storing hooked objects of various shapes and sizes, such as fishing lures.

### BACKGROUND OF THE INVENTION

A lure is an object equipped with one or many hooks that is used to attract and catch fish. A great variety of lures are available to the angler such as, for example, jigs, wobblers, spinners, spoon lures, and fly lures. Lures are often selected based the type of fish being sought, the diet of the target fish, the time of day, season, and innumerable other factors.

Given the great diversity in the types, shapes, and sizes of lures, a tackle box is one of the basic necessities of fishing. As with lures, tackle boxes come in many different types, shapes, sizes, and styles, some of which will suit specific types of fishing.

For example, fold-out or hip-roof tackle boxes generally include one or two tackle trays and a larger bottom compartment. Lures and other fishing tackle are stored by horizontally laying them down in the trays and bottom compartment of the tackle box.

Another type of tackle box is the drawer box, which also provides horizontal storage for bait, lures and other tackle horizontally in drawers. Drawer boxes require large clearance when opening and are therefore not the most portable among tackle boxes.

Utility boxes can also be used to store lures and other tackle. However, utility boxes typically have low profiles and are therefore unsuitable for storing bulky lures and tackle.

Most tackle boxes are designed to accommodate small to medium sized fishing lures in horizontal compartments or trays. Larger lures, such as muskie bait or swim bait, do not typically fit within these horizontal compartments or trays. Accordingly, large lures must be stored in the container in which they are purchased or stored in the main compartment of the tackle box.

However, because large lures take up a significant amount of space, only a few lures may effectively be stored in the main compartment. Additionally, storing multiple lures in the main compartment often leads to the lures becoming entangled with each other and with other items in the tackle box. This, in turn, results in the barbs of the lure hooks becoming bent or dulled.

A tackle box is as important to an angler, as a camera bag is to a photographer. There is a continuing need for new and improved systems for organizing and storing fishing tackle that saves space, minimizes entanglement, and facilitates ease of selection. Moreover, given the large variety of lures available to the angler, it would be desirable to have a system that is capable of effectively organizing and storing lures of a variety of shapes, sizes and configurations.

### BRIEF SUMMARY OF THE PREFERRED EMBODIMENTS

The storage systems disclosed and described herein provide compartments that are adaptable for storing hooked objects of most shapes and sizes, such as fishing lures. The storage systems are particularly well-adapted for organizing and storing large or bulky lures, which do not typically fit in most presently known tackle boxes. The storage system is also applicable to storing hooked objects other than fishing lures.

In accordance with one aspect of the present invention, a storage system for storing a plurality of hooked objects is provided. The storage system comprises at least one chamber having side walls and at least one guide member disposed on the chamber side walls. Partition members are disposed in the chambers. The partition members each comprise a body having apertures to support at least one hooked object and the partition members are supported in the chamber by at least one guide member in a substantially vertical position.

In preferred embodiments, the storage system further comprises a container having front, back, side, and bottom panels, wherein the at least one chamber is at least partially disposed in the container. In other preferred embodiments, the container further comprises a top cover and at least one handle. In yet other preferred embodiments, the container further comprises at least one pocket disposed on the container. In still further preferred embodiments, the bottom panel of the container may further comprise a first set of drain holes.

In other preferred embodiments, the storage system comprises a plurality of chambers. In one preferred embodiment, the plurality of chambers form a single integral unit. In other preferred embodiments, the plurality of chambers form separate units. In yet other preferred embodiments, the chamber further comprises a bottom wall coupled to the side walls. In yet another preferred embodiment, the bottom wall comprises a second set of drain holes.

In further preferred embodiments, the guide members are adapted to slidably receive the partition members into the chamber. In accordance with one preferred embodiment, the guide member is a track which mates with the body of the partition member. In accordance with another preferred embodiment, the guide member is a recess formed in the chamber side walls into which the partition member may be inserted.

In yet further preferred embodiments, a plurality of guide members are disposed on the opposing side walls of the chamber. In this preferred embodiment, adjacent partition members may be positioned in the chamber at varying relative distances from one another to form compartments of varying sizes.

In still further preferred embodiments, the partition members each have a planar body and are supported in the chamber by guide members. In accordance with one preferred embodiment, apertures are disposed at the top and middle of the partition member body. In accordance with another preferred embodiment, apertures are disposed substantially throughout the partition member body.

In one preferred embodiment, each partition member is supported in the chamber by one guide member. In other preferred embodiments, the partition members are supported in the chamber by two or more guide members. In accordance with these embodiments, the guide members are disposed on one side wall or on opposing side walls.

In yet further preferred embodiments, the partition member comprises at least two planar bodies joined together at an angle. In one preferred embodiment, the partition member may be supported in the chamber by one guide member. In another preferred embodiment, the partition member may be supported in the chamber by two or more guide members on adjacent chamber side walls.

In accordance with another aspect of the present invention, a storage system for storing a plurality of objects is provided. The storage system comprises at least one chamber having side walls, a plurality of guide members disposed on one or more side walls, and partition members supported in the chamber by the guide members, wherein the partition members form compartments of varying sizes in the chamber.

In preferred embodiments, the partition members each comprise planar bodies. In other preferred embodiments, the partition members each comprise two or more planar bodies joined together at an angle, and preferably at a substantially right angle.

In other preferred embodiments, the guide members supporting the partition members are disposed on one side wall. In yet other preferred embodiments, the guide members are disposed on adjacent side walls. In still other preferred embodiments, the guide members are disposed on opposing side walls to support the partition members.

In further preferred embodiments, the guide members are spaced on the side walls at equal distance intervals. In yet further preferred embodiments, the guide members are spaced on the side walls at irregular distance intervals.

In accordance with yet another aspect of the present invention, storage system for storing a plurality of hooked objects are provided. The storage system comprises support means for storing one or more hooked objects on the support means, hooking means disposed on the support means for removably attaching hooked objects onto the support means, and storage means comprising a plurality of guide means to maintain the support means in the storage means for ease of transport.

In accordance with yet a further aspect of the present invention, methods are provided for making a storage system for storing a plurality of hooked objects. The method preferably comprises forming at least one chamber having side walls, adding at least one guide member onto the chamber side walls, and providing a plurality of partition members, the partition members each having apertures configured to removably support hooked objects on the partition member.

Other objects, features and advantages of the present invention will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The invention may be more readily understood by referring to the accompanying drawings in which:

FIG. 1 is a perspective view of a preferred embodiment of the storage system.

FIG. 2 is a top view of the embodiment of the storage system of FIG. 1.

FIG. 3 is a perspective view of a preferred embodiment of the storage system.

FIG. 4 is a top view of the embodiment of the storage system of FIG. 2.

FIG. 5 is a front view of a preferred embodiment of a partition member having two sets of apertures at the top and middle sections of the partition body.

FIG. 6 is a front view of another preferred embodiment of a partition member having apertures disposed substantially throughout the partition body.

Like numerals refer to like parts throughout the several views of the drawings.

### DETAILED DESCRIPTION OF THE PREFERRED EMBODIMENTS

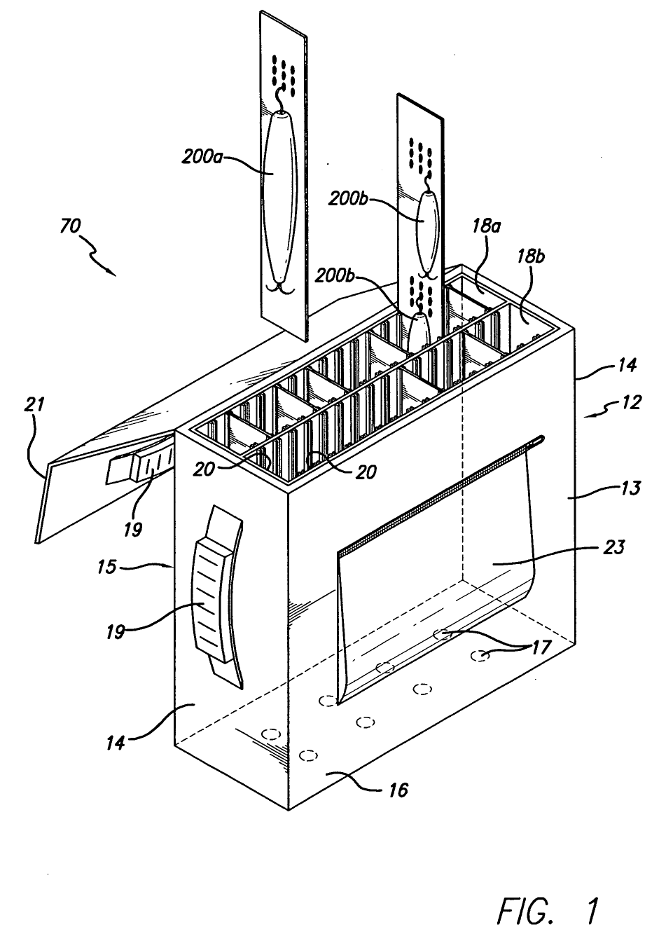

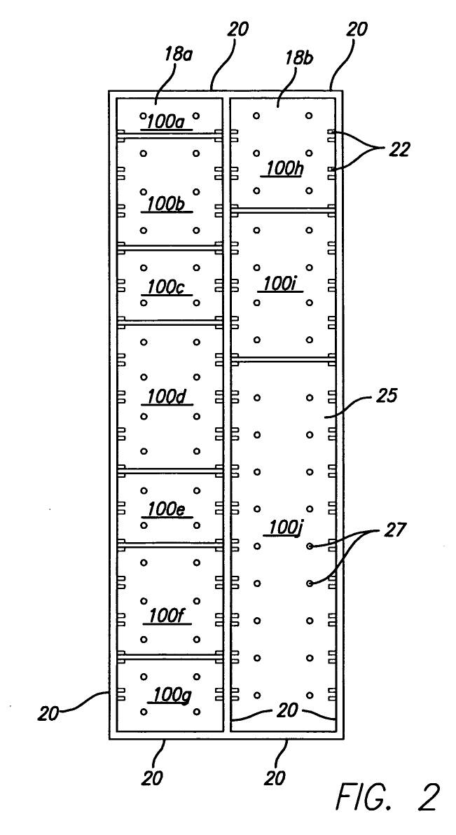

With reference generally to FIGS. 1-2, a preferred embodiment of the storage system (10) is shown. The container (12) has a front panel (13), a pair of side panels (14), a back panel (15) and a bottom panel (16). The bottom panel (16) may optionally include a first set of drain holes (17) to permit drainage of any fluid in the container (12) and to permit easy rinsing and cleaning of the container (12).

The container (12) may constructed from material that is rigid (i.e., plastic, metal, etc.) or pliable (i.e., fabric, cloth, tarpaulin, etc.). Optionally the container (12) may be constructed from waterproof material or from non-waterproof material that is treated to render it waterproof.

The container (12) may optionally include handles (19) and a top cover (21) that may be removed to access the fishing lures stored within the chamber. The container may also optionally include pockets (23) for the storage of other fishing tackle items.

The preferred embodiments in FIGS. 1-2 show the storage system (10) having two chambers (18a, 18b) each having a pair of opposing side walls (20). The chambers (18a, 18b) are removably disposed in the container (12) to create compartments of varying sizes (100a-j). The chamber may further comprise a bottom wall (25) coupled to the side walls (20) and comprising a second set of drain holes (27).

In one preferred embodiment, the two chambers (18a, 18b) may be formed from an integral unit. In another preferred embodiment, the two chambers (18a, 18b) may be formed from two units which are separable from one another. Regardless, with particular reference to FIG. 2, each of the chambers (18a, 18b) have a pair of opposing side walls (20) and a plurality of guide members (22) disposed on the opposing side walls (20).

The guide members (22) are configured to receive the partition members (30) and to secure the partition members (30) in the chambers (18a, 18b). Hooked objects, such as fishing lures (200a, 200b), are supported on the partition members (30) and stored in the chambers (18a, 18b) in a substantially vertical position.

A plurality of guide members (22) are disposed along a the opposing side walls (20) of the chambers (18a, 18b). The guide members (22) provide flexibility with respect to the placement of the adjacent partition members (30) in the chambers (18a, 18b) to form compartments of varying sizes. Thus, fishing lures (200a, 200b) of various sizes may be accommodated and stored in the chambers (18a, 18b) by positioning adjacent partition members (30) at varying distances from one another to form compartments (100a-j).

As shown in FIG. 2, adjacent partition members (30) may be placed farther apart from one another in the chambers (18a, 18b) for the storage of large lures (200a) in the larger compartments (100h-j). Alternatively, adjacent partition members (30) may be placed closer together in the chambers (18a, 18b) for the storage of smaller lures (200b) in the smaller compartments (100a-c, e-g).

The guide members (22) may either span a part of or the entire vertical length of the chamber side walls (20). The guide members (22) may be in form of tracks (20) or recesses formed in the side walls through which the partition member (30) may slide into and be supported in the chambers. The guide members (22) may be formed in any other number of ways, known to one of ordinary skill in the art, so long as the guide members (22) are able secure the partition member (30) once it is positioned in the chamber (18a, 18b).

Although FIGS. 1-2 show the plurality of guide members (22) spaced on the side walls (20) at roughly equal distance intervals, the plurality of guide members (22) may also be spaced on the side walls (20) at irregular distance intervals.

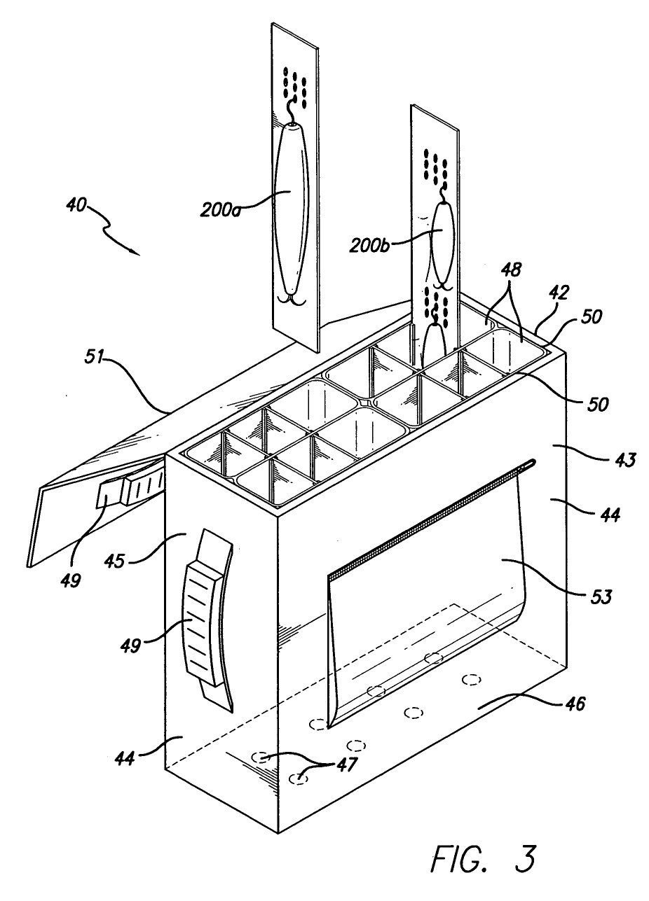

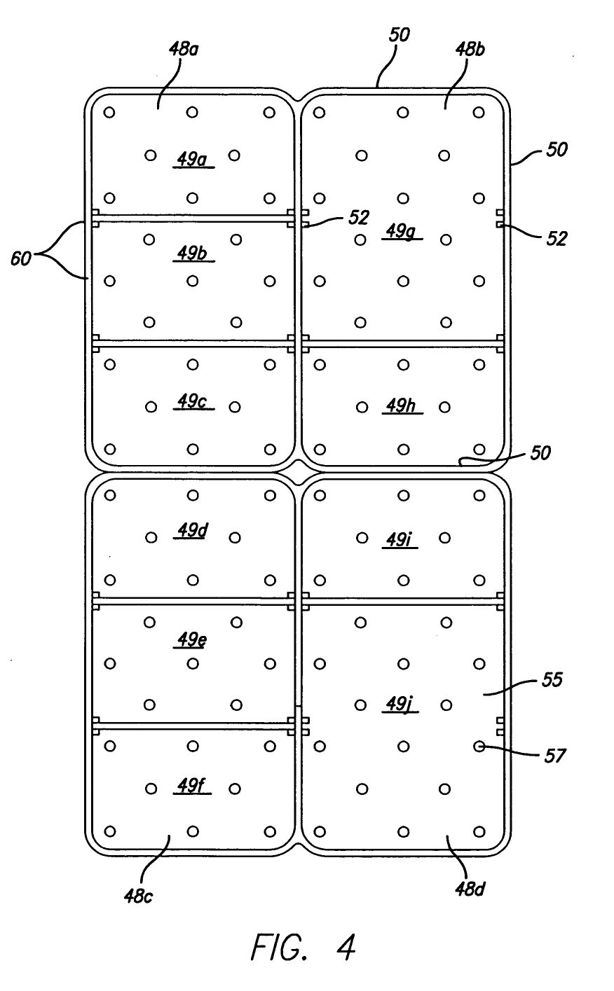

FIGS. 3-4 show another preferred embodiment of the storage system (40). In this preferred embodiment, the container (42) has a front panel (43), a pair of side panels (44), a back panel (45) and a bottom panel (46). The bottom panel (46) may preferably include a first set of drain holes (47) to permit drainage of any fluid in the container (42) and to permit easy rinsing and cleaning of the container (42). The container (42) may be constructed from the same materials as for the container (12) depicted in FIG. 1.

The container (42) may optionally include handles (49) and a top cover (51) that may be removed to access the fishing lures stored within the container. The container may also optionally include pockets (53) for the storage of other fishing tackle items.

The preferred embodiment depicted in FIGS. 3-4 show the storage system (40) having four chambers (48a-d) having side walls (50). In one embodiment, the four chambers (48a-d) may be formed from an integral unit. In another embodiment, the four chambers (48a-d) may be formed from up to four separate units. The preferred embodiment in FIGS. 3-4 show the four chambers (48a-d) provided as two separate units (48a, 48b) and (48c, 48d), each comprising two chambers and each separately removable from the container (42).

The chambers (48a-d) are each depicted as each having a pair of opposing side walls (50). The chambers preferably comprise a bottom wall (55) coupled to the side walls (20) and comprising a second set of drain holes (57) to permit fluid to drain out of the chambers (48a-d).

Although two pairs of guide members (52) are depicted in each of the chambers (48a-d) in FIGS. 3-4, it is understood and contemplated that the chambers (48a-d) may each contain any number of guide members. In FIGS. 3-4, the storage system (40) is depicted as having a total of eight pairs of guide members (52). In the embodiment depicted in FIG. 4, two partition members (60) are depicted in each of the two chambers (48a, 48c) to form six small compartments (49a-f) and one partition member (60) is depicted in the remaining two chambers (48b, 48d) to form two large compartments (49g, 49j) and two small compartments (49h, 49i).

Each guide member (52) is configured to slidably receive a partition member (60) and to secure the partition member (60) in the chambers (48a-d) to form compartments (49a-j). The guide members (52) may either span a part of or the entire vertical distance of the side walls (50) of the chamber (48a-d). The guide members (52) may be in form of tracks (50) or recesses formed in the side walls (50). The guide members (52) may be formed in any number of ways, known to one of ordinary skill in the art, so long as the guide members (52) can secure the partition member (60) once it is positioned in the chamber (48a-d).

Although FIGS. 1-4 show guide members disposed on the chamber opposing side walls, it is understood that the guide members may also be disposed on a single side wall or on adjacent side walls, depending on the configuration desired for the compartments in the storage system. For example, the partition member may comprise at least two planar bodies joined together at an angle. In this embodiment, the partition member may be supported in the chamber by one guide member. In another preferred embodiment, the partition member may be supported in the chamber by two or more guide members on adjacent chamber side walls.

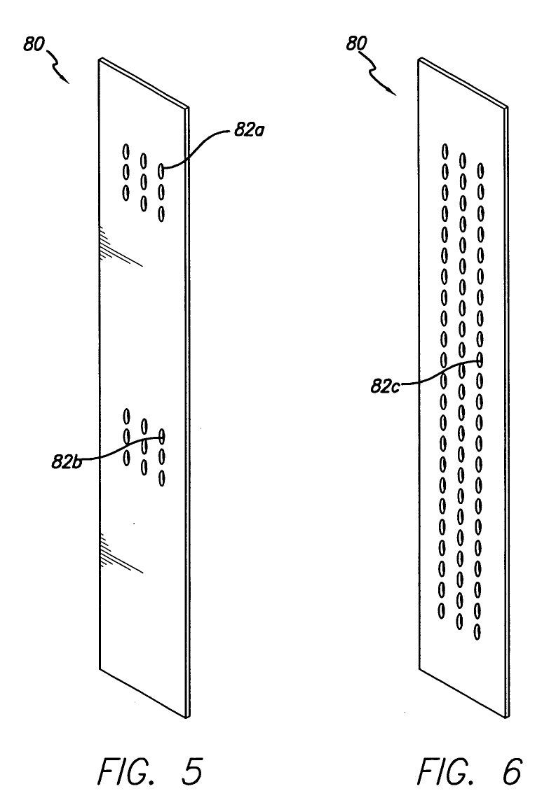

FIGS. 5-6 show preferred embodiments of the partition member (80) that can be used in connection with the storage system of FIGS. 1-4. In FIG. 5, the partition member (80) comprises a front side and a back side and two sets of apertures (82a-b) therethrough. The first set of apertures (82a) is located at the top section of the partition member (80) and the second set of apertures (82b) is located at the middle section of the partition member (80). In an alternative embodiment, as shown in FIG. 6, apertures (82c) may be provided substantially throughout the partition member body.

Fishing lures of various shapes and sizes may be stored on the partition member (80) by placing the lure hooks through any one or more of the plurality of apertures (82a-c) of the partition member (80) of FIGS. 5 and 6. The partition member (80) provides great flexibility in storing lures of various shapes and sizes due to the presence of the plurality of apertures (82a-c) on the partition member (80). The partition members are slidably removable from the chambers to permit viewing of the lures stored therein.

For example, lures that are particularly long or bulky may be stored by placing the lure hooks through the apertures located at the top section (82a) of the partition member (80). Lures may be stored on one or both sides of a single partition member (80). In this manner, each partition member (80) may accommodate up to two long or bulky lures.

Alternatively, shorter or smaller lures may be stored on the partition member (80) by placing the lure hooks in the apertures at the top section (82a) and at the middle section (82b). Again, because a plurality of apertures are provided both at the top section (82a) and middle section (82b) of the partition member (80), such lures may be stored at both the front and back sides of a single partition member (80) to accommodate up to four small lures.

Although the partition members in FIGS. 5-6 are depicted as having planar bodies which are substantially rectangular in shape, it is understood that the partition member may configured into a variety of shapes and sizes, so long as the partition member can be secured in the chambers by the guide members.

In other embodiments, not shown in the Figures, the partition members may each comprise two or more planar bodies joined together at an angle, and preferably at a substantially right angle. Partition members formed in this manner may be supported by guide members disposed on a single side wall or on adjacent side walls.

The invention described and claimed herein is not to be limited in scope by the specific preferred embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

1. A storage system for storing a plurality of hooked objects, the storage system comprising:
at least one chamber having side walls;
at least one guide member disposed on the chamber side walls; and
partition members disposed in the chamber, the partition members each comprising a body having apertures to support at least one hooked object;
wherein the partition members are supported in the chamber by the at least one guide member in a substantially vertical position.

2. The storage system of claim 1 further comprising a container having front, back, side, and bottom panels, wherein the at least one chamber is at least partially disposed in the container.

3. The storage system of claim 2, wherein the container further comprises a top cover and at least one handle.

4. The storage system of claim 2, wherein the container further comprises at least one pocket disposed on the container.

5. The storage system of claim 2, wherein the bottom panel of the container comprises a first set of drain holes.

6. The storage system of claim 1, wherein the storage system comprises a plurality of chambers.

7. The storage system of claim 6, wherein the plurality chambers form a single integral unit.

8. The storage system of claim 6, wherein the plurality of chambers form separate units.

9. The storage system of claim 1, wherein the at least one chamber further comprises a bottom wall coupled to the side walls.

10. The storage system of claim 9, wherein the bottom wall further comprises a second set of drain holes.

11. The storage system of claim 1, wherein the at least one guide member is adapted to slidably receive the partition member into the chamber.

12. The storage system of claim 11, wherein the guide member is a track which mates with the body of the partition member.

13. The storage system of claim 11, wherein the guide member is a recess formed in the chamber side walls into which the partition member may be inserted.

14. The storage system of claim 1, wherein the partition member has a planar body.

15. The storage system of claim 14, wherein the apertures are disposed substantially throughout the partition member body.

16. The storage system of claim 14, wherein the apertures are disposed at the top and middle of the partition member body.

17. The storage system of claim 14, wherein the partition member is supported in the chamber by one guide member.

18. The storage system of claim 14, wherein the partition member is supported in the chamber by two or more guide members.

19. The storage system of claim 18, wherein the two or more guide members are disposed on one side wall.

20. The storage system of claim 18, wherein the two or more guide members are disposed on opposing side walls.

21. The storage system of claim 1, wherein the partition member comprises at least two planar bodies, the two planar bodies joined together at an angle.

22. The storage system of claim 21, wherein the partition member is supported in the chamber by one guide member.

23. The storage system of claim 21, wherein the partition member is supported in the chamber by two or more guide members on adjacent chamber side walls.

24. The storage system of claim 1, wherein a plurality of guide members are disposed on the opposing side walls of the chamber.

25. The storage system of claim 24, wherein adjacent partition members may be positioned in the chamber at varying relative distances from one another to form compartments of varying sizes.

26. A storage system for storing a plurality of objects, the storage system comprising:
at least one chamber having side walls;
a plurality of guide members disposed on one or more side walls; and
partition members supported in the chamber by the guide members;
wherein the partition members form compartments of varying sizes in the chamber.

27. The storage system of claim 26 where the partition members each comprise planar bodies.

28. The storage system of claim 26, wherein the partition members each comprise two or more planar bodies joined together at an angle.

29. The storage system of claim 28, wherein the two or more planar bodies are joined together at a substantially right angle.

30. The storage system of claim 29, wherein the guide members are disposed on adjacent side walls.

31. The storage system of claim 26 wherein the guide members are disposed on one side wall.

32. The storage system of claim 26 wherein the guide members are disposed on opposing side walls.

33. The storage system of claim 26 wherein adjacent guide members are spaced on the side walls at equal distance intervals.

34. The storage system of claim 26, wherein the guide members are spaced on the side walls at irregular distance intervals.

35. A storage system for storing a plurality of hooked objects, the storage system comprising:
support means for storing one or more hooked objects on the support means;
hooking means disposed on the support means for removably attaching hooked objects onto the support means; and
storage means comprising a plurality of guide means to maintain the support means in the storage means for ease of transport.

36. A method of making a storage system for storing a plurality of hooked objects, the method comprising:
forming at least one chamber having side walls;
adding at least one guide member onto the chamber side walls; and
providing a plurality of partition members, the partition members each having apertures configured to removably support hooked objects on the partition member;
wherein the guide members are configured to support the partition member in a substantially vertical position in the chamber.
